(19) United States
(12) Patent Application Publication
(10) Pub. No.: US 2005/0164699 A1
(43) Pub. Date: Jul. 28, 2005

(54) Remote switching a communication device in a communication network

(76) Inventors: Christopher Temple, Munich (DE); Mathias Rausch, Markt Schwaben (DE)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/508,620

(22) PCT Filed: Nov. 1, 2002
(86) PCT No.: PCT/EP02/12276

(30) Foreign Application Priority Data
Mar. 22, 2002 (GB) 02067379

(51) Int. Cl. H04Q 7/20

(52) U.S. Cl. 455/424

(57) ABSTRACT

A communication network (300, 400), and (D1-D3, D11-D13, 500) for use therein, comprising a plurality of nodes (N1-N4, N11-N13), a communication medium for communicating between the plurality of nodes; and communication diode arrangement(s) (D1-D3, D11-D13, 500) for controlledly enabling/disabling access of the node(s) to the communication medium by control external to the node(s). The communication diode arrangement(s) can enforce fail-silence in the time domain within a distributed computer system, showing resilience against spatial proximity faults. The communication diode arrangement(s) may be controllable not only by time but also by commands embedded in frames. This allows isolation of a faulty processing node and/or subnets within an embedded distributed real-time communication system, such as for automotive by-wire applications (FlexRay, TTP), under consideration of spatial proximity faults.

### FIELD OF THE INVENTION

This invention relates to communication networks and particularly, though not exclusively, to embedded, fault-tolerant, dependable, distributed computer systems.

### BACKGROUND OF THE INVENTION

In a distributed physical real-time system based on shared communication media, such as a broadcast bus or star topology, it is important to prevent a single faulty node from monopolizing the communication media. Since it cannot be assumed that a faulty node obeys the system's media arbitration policy, but that it will rather send messages at arbitrary points in time, it is necessary to protect the communication media against such uncontrolled node failures.

Two approaches are known for protecting shared communication media against uncontrolled node failures. Both approaches assume a regular, temporal deterministic media access scheme:
A first approach proposes integrating a device, called bus guardian, with each node that controls the node's access to the communication media. The bus guardian is provided with apriori information about the transmission scheme of its associated node and enforces that access to the communication media is only given in accordance with the transmission scheme.
A second approach is based on a star topology. It proposes integrating a distribution unit within the star coupler granting access of the respective nodes to the star according to a cyclical time slice method. Again the distribution unit, which is provided apriori before run-time with the transmission scheme of the connected nodes, imposes that at a given instant only one node is capable of transmitting to the remaining nodes according to the transmission scheme.

From U.S. Pat. No. 4,015,246, titled “Synchronous Fault Tolerant Multi-Processor System”, there is known a bus guardian for a non-distributed fully synchronous multi-processing system based on very specific architectural assumptions (mininmum 3 buses, 6 processors).

From U.S. Pat. No. 4,860,280, titled “Apparatus and Method for a sSecure and Diagnosable Antijabber Communication Circuit”, it is known that in order to prevent ‘jabber’ (the uncontrolled transmission of messages on a communication channel) an anitjabber timing unit is frequently used to determine whether a message on the communication channel exceeds the maximum predetermined length of time.

From the publication of the Institut für Technische Informatik, Technische Universitat Wien, titled “Avoiding the Babbling-Idiot Failure in a Time-Triggered Communication System”, it is known to use a bus guardian added to each node to protect a communication bus from babbling-idiot failure by exploiting the regular transmission poattern of a time-triggered system in order to enforce fail-silent behaviour of the node in the time domain.

From patent publication WO 0113230 A1, 2001, titled “Method for Imposing the Fail-Silent Characteristic in a Distributed Computer System and Distribution Unit in such a System”, it is known to use a server-interconnecting distribution unit which knows apriori the servers' regular transmission pattern and imposes that a server is only able to transmit to remaining servers within a statically allocated time slice. From U.S. Pat. No. 5,355,375, titled “Hub Controller for Providing Deterministic Access to CSMA Local Area Network”, it is known to alter a basic non-deterministic contention algorithm of the CSMA/CD protocol LAN within a hub controller to inhibit any CSMA/CD transmissions by a port, allowing the hub controller to control which of the multiple ports will be allowed to contend for access to a common internal bus within the hub controller and for how long.

It will be understood that these known techniques fall into one of the two approaches summarized above.

However, both approaches suffer from drawbacks:
The first approach suffers as it relies on functional independence between the node and its associated bus guardian in the event of a fault, since perceivable faults may cause not only the node but also its associated bus guardian to fail in an uncontrolled way. Due to the physical proximity of the two units this independency cannot always be convincingly ensured.
The second approach suffers from use of a star coupler. In many environments it is not feasible to run a communication channel from every node to the star coupler for economical reasons. In addition, the star coupler represents a single point of failure in the system that has a higher probability of failure compared to a passive component such as a bus as it contains a significant number of active components, such as, for example, a microcontroller.

A need therefore exists for a communication network and arrangement for use therein wherein the abovementioned disadvantage(s) may be alleviated.

### STATEMENT OF INVENTION

In accordance with a first aspect of the present invention there is provided a communication network as claimed in claim 1.

In accordance with a second aspect of the present invention there is provided an arrangement for use in a communication network as claimed in claim 9.

In brief, the invention proposes introducing an arrangement or component into a network, such as a distributed system, the component operating as a “communication diode”. This component is placed at strategic positions within the communication network, where it serves as a firewall for uncontrolled node failures. This allows the enforcement of fail-silence in the time domain within a distributed computer systems showing resilience against spatial proximity faults.

### BRIEF DESCRIPTION OF THE DRAWINGS

One communication network and arrangement for use therein incorporating the present invention will now be described, by way of example only, with reference to the accompanying drawing(s), in which:

FIG. 1 shows a schematic block-diagram illustrating a known guard device located within and controlled by a processing node in a prior art communication network;

FIG. 2 shows a schematic block-diagram illustrating a known guard device located within and controlled by a central distribution unit in a prior art communication network;

FIG. 3 shows a schematic block-diagram illustrating the structure of a novel communication diode for use in a communication network incorporating the invention; and

FIG. 4 shows a schematic block-diagram illustrating a communication network containing four nodes and three communication diodes, as shown in FIG. 3, incorporating the invention; and

FIG. 5 shows a schematic block-diagram illustrating a communication network containing three nodes and three communication diodes, as shown in FIG. 3, incorporating the invention.

### DESCRIPTION OF PREFERRED EMBODIMENT

In brief, the invention in one aspect introduces an arrangement or component into a distributed system that operates as a “communication diode”. This component is placed at one or more strategic positions within the communication network, where it serves as a firewall for uncontrolled node failures.

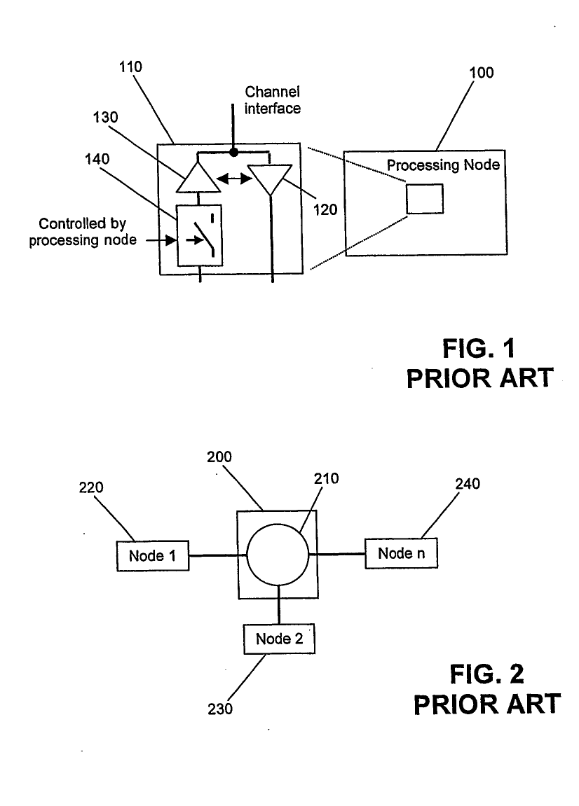

FIG. 1 shows a first, known prior art approach in which each node 100 includes a device 110, typically termed a bus guardian, that controls the node's access to the communication media. The bus guardian 110 contains input and output amplifiers 120 and 130; the bus guardian 110 also contains a switch 140, controlled by the processing node, which enables or disables the node for outputting signals to a channel interface (and thereby onto the communication media). The bus guardian 110 is provided with apriori information about the transmission scheme of its associated node and enforces that access to the communication media is only given in accordance with the transmission scheme.

It will be appreciated that the approach illustrated in FIG. 1 suffers as it relies on functional independence between the node and its associated bus guardian in the event of a fault, since perceivable faults may cause not only the node but also its associated bus guardian to fail in an uncontrolled way, and due to the physical proximity of the two units this independency cannot always be convincingly ensured.

FIG. 2 shows a second known, prior art approach which is based on a star topology. A star coupler 200 has integrated within it a distribution unit 210 which grants access of the respective nodes 1-n (of which only three, node 220, node 230 and node 240 are shown) to the star coupler 200 according to a cyclical time slice method. Similarly to the approach of FIG. 1 discussed above, the distribution unit 210 is provided apriori before run-time with the transmission scheme of the connected nodes, and imposes that at a given instant only one node is capable of transmitting to the remaining nodes according to the transmission scheme.

It will be appreciated that the approach illustrated in FIG. 2 suffers from use of a star coupler. In many environments it is not feasible to run a communication channel from every node to the star coupler for economical reasons. In addition, the star coupler represents a single point of failure in the system that has a higher probability of failure compared to a passive component such as a bus since it contains a significant number of active components, such as, for example, a microcontroller.

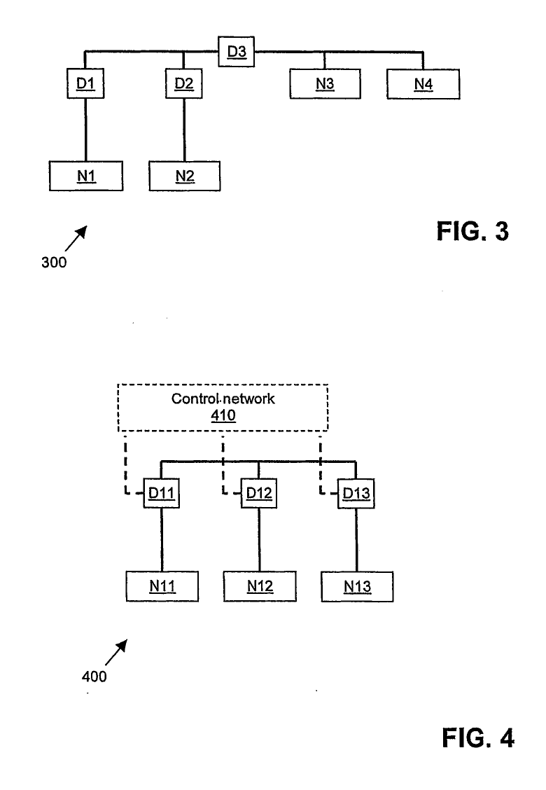

Referring now to FIG. 3, a network 300 incorporating the present invention contains four nodes N1-N4 and three components D1-D3, termed ‘communication diodes’, which will be explained in more detail below. The communication diode D1 is connected between the node N1 and the communication medium; the communication diode D2 is connected between the node N1 and the communication medium; and the communication diode D3 is connected between the node N3 & N4 and the communication medium. As will be explained in greater detail below, the communication diodes D1-D3 are controlled to enable/disable their respective nodes from accessing the communication medium.

A key virtue of the invention is its versatility: the communication diode can be deployed in a multitude of ways—it can not only be used to protect a shared communication media like a bus or a star from a node (illustrated in FIG. 3 with D1 and D2) but it can also protect subnets from subnets (illustrated with D3). It is also possible to use the communication diode to physically move the node from the bus connection as shown for node N1 and node N2. In addition it is possible to operate the diodes in a unidirectional or bi-directional way.

FIG. 4 shows a communication network 400 where a separate disjoint control network 410 interconnects three nodes N11-N13, which are coupled to communication medium 420 by respective communication diodes D11-D13.

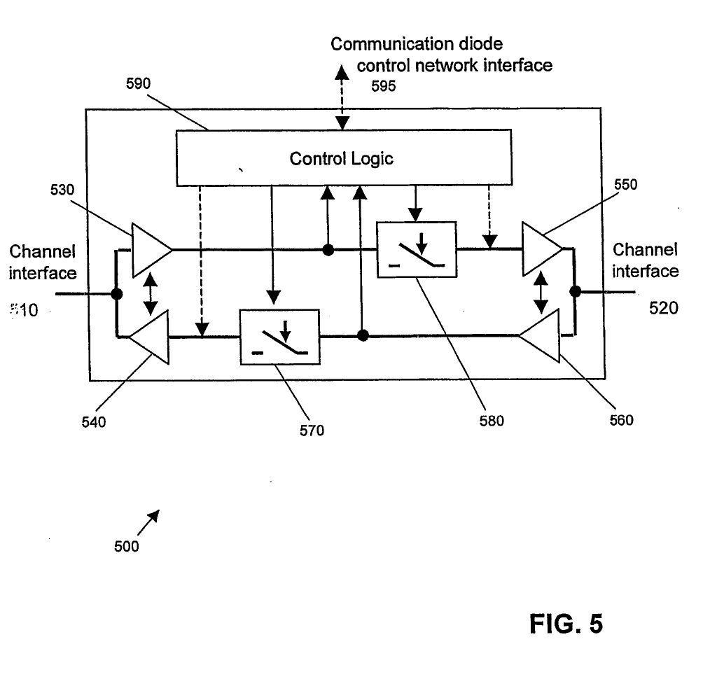

FIG. 5 illustrates the structure of a communication diode, which may be used as the communication diodes D1-D3 and D11-D13. The communication diode 500 has two communication channel interfaces 510 & 520 (having interface amplifiers 530, 540, 550 & 560), switches 570 & 580 and control logic 590. The control logic 590 contains the rule base used to control the switches. The rules may range from a pure time-access pattern to more sophisticated rules that consider and/or are controlled by packets that are picked up by the communication diode at an interface 595. Optional connections (dashed lines) indicate that it is also possible to have the communication diode communicate with other devices, for example, for maintenance purposes. The optional interface from the control logic can be used, for example, to connect the communication diode to a separate control network (not shown).

It will be understood that the networks 300 and 400 provide a dependable communication in the event of node error/failure by enforcing fail-silence of the node in the time domain. It will be understood that these networks provide isolation of a faulty processing node and/or subnets within an embedded distributed real-time communication system such as, for example, in automotive by-wire applications (‘FlexRay’, ‘Time-Triggered Protocol’-TTP) under consideration of spatial proximity faults.

In summary, it will be appreciated that the networks 300 and 400 provide:
spatial separation between processing node and guards
they may be placed within the network line (allowing eavesdropping)
they require no control signals from processing nodes (since they are controlled by a separate control network among guards)
they may be controlled not only by time but also by commands embedded in frames.

It will further be understood that the communication diode 500 may conveniently be fabricated in integrated circuit form (not shown), and may be inserted as desired at one or more points in a network to provide the advantageous functionality described above.

1. A communication network comprising:
a plurality of nodes;
a communication medium for communicating between the plurality of nodes; and
communication diode means for controlledly enabling/disabling access of at least one of the plurality of nodes to the communication medium by control means external to the at least one of the plurality of nodes,
such that isolation of a faulty node and/or subnets within the communication network can be achieved.

2. The communication network of claim 1, wherein the communication diode means comprises:
channel interface means for interfacing between the diode means and a communication channel; and
switch means for enabling/disabling signals on the channel.

3. The communication network of claim 2, wherein the switch means comprises:
first direction switch means for enabling/disabling signals in a first direction on the channel; and
second direction switch means for enabling/disabling signals in a second direction on the channel opposite the first direction.

4. The communication network of claim 1, wherein the communication diode means is arranged to be controlled by time-based control signals from an external control network.

5. The communication network of claim 1, wherein the communication diode means is arranged to be controlled by frame-based control signals from an external control network.

6. The communication network of claim 1, wherein the network comprises a distributed computer system.

7. The communication network of any claim 1, wherein the network is arranged for real-time communication.

8. The communication network of claim 1, wherein the network is arranged for use in an automotive application.

9. An arrangement for use in a communication network having a plurality of nodes, and a communication medium for communicating between the plurality of nodes, the arrangement comprising communication diode means for controlledly enabling/disabling access of at least one of the plurality of nodes to the communication medium by control means external to the at least one of the plurality of nodes such that isolation of a faulty node and/or subnets within the communication network can be achieved.

10. The arrangement of claim 9, wherein the communication diode means comprises:
channel interface means for interfacing between the diode means and a communication channel; and
switch means for enabling/disabling signals on the channel.

11. The arrangement of claim 10, wherein the switch means comprises:
first direction switch means for enabling/disabling signals in a first direction on the channel; and
second direction switch means for enabling/disabling signals in a second direction on the channel opposite the first direction.

12. The arrangement of claim 9, wherein the communication diode means is arranged to be controlled by time-based control signals from an external control network.

13. The arrangement of claim 9, wherein the communication diode means is arranged to be controlled by frame-based control signals from an external control network.

14. The arrangement of claims 9, wherein the network comprises a distributed computer system.

15. The arrangement of any one of claim 9, wherein the network is arranged for real-time communication.

16. The arrangement of claim 9, wherein the network is arranged for use in an automotive application.

17. An integrated circuit comprising the arrangement of claim 9.
